(19) United States
(12) Patent Application Publication
(10) Pub. No.: US 2015/0156151 A1
(43) Pub. Date: Jun. 4, 2015

(54) EMAIL DYNAMIC CONTENT RIBBON

(71) Applicant: POWERINBOX LTD, Petach Tikva (IL)

(72) Inventors: Ohad SHEORY, Yehud (IL); Jeffrey KUPIETZKY, Petach Tikva (IL)

(21) Appl. No.: 14/559,969

(22) Filed: Dec. 4, 2014

Related U.S. Application Data
(60) Provisional application No. 61/911,571, filed on Dec. 4, 2013.

(51) Int. Cl. H04L 12/58; G06F 17/22

(52) U.S. Cl. CPC H04L 51/10; G06F 17/227

(57) ABSTRACT

A method and system for sending email messages to a recipient, wherein the email messages contain interactive dynamic content that can be displayed by the recipient's email client on the recipient's email-reading device without requiring the recipient to launch additional applications. Embodiments of the invention feature a dynamic “ribbon” containing multiple images that automatically scroll across the screen to display a changing subset of the multiple images without requiring the recipient to manually scroll. The recipient can click or tap on an image at any time to obtain more detailed information about a product or service represented by an image.

This application claims benefit of U.S. Provisional Patent Application Ser. No. 61/911,571, filed Dec. 4, 2013, entitled “Email dynamic content ribbon”, the disclosure of which is hereby incorporated by reference and the priority of which is hereby claimed pursuant to 37 CFR 1.78(a) (4) and (5)(i).

### BACKGROUND

Senders of email messages often prefer that a recipient be able to view, select, and manipulate content of an email message directly in the email message as presented by the recipient's email client, without requiring the recipient to do so by launching a separate application.

Unfortunately, most email clients support HTML but filter out scripts like Javascript and some other tags or elements. Thus, interactivity and dynamic content which is implemented in websites via scripts, is typically disabled in emails Currently, techniques for enabling dynamic content via an email client involve using animated Graphics Interchange Format (“GIF”) files or progressive downloads which overwrite one image with another. However, animated GIF as well as other means of sequential image display requires downloading an entire animation to the client and can only be played as a video, because an image object embedded in email can have only one attached link.

It is therefore desirable to overcome the above restrictions in order for the recipient to be able to view dynamic moving content as presented by the recipient's email client, without requiring the recipient to view the content via a separate application. This goal is met by embodiments of the present invention.

### SUMMARY

Various embodiments of the present invention provide interactivity and dynamic content within email clients without a need to be assisted by or to install a client side package. Certain embodiments achieve this by combining selected style formatting functionalities with interactive HTML capabilities within an iframe (“Inline Frame”), thereby embedding individual visual items within email messages, to allow an item or items to be moved, hidden or shown, flipped, and animated based on timeline, sequence, or other initiation methods.

Certain embodiments of the invention provide a dynamically-moving “ribbon” within an email message, which automatically scrolls images across the screen of the recipient's email reader device, permitting the recipient to conveniently view a number of different images within the email client, without having to manually scroll the image display or launch additional applications. A non-limiting use of a ribbon according to these embodiments is in email messages from an e-commerce store. A recipient of an email with a ribbon can view product or service offerings, and can click or tap on a specific image for obtaining further information or for placing an order.

According to various embodiments of the invention, an email message contains an HTML block which includes a reference to an iframe. In related embodiments, code is delivered to the iframe when the email is opened by the recipient, and the code is run at the time the message is opened. In this manner, embodiments of the present invention provide the ribbon code and its contents at the time the email is opened, rather than at the time the email is composed for sending. Thus, the recipient sees up-to-date content in the dynamic ribbon whenever he or she opens the email

In certain embodiments of the present invention, a dynamic ribbon is provided by an HTML iframe. In other various embodiments, an HTML iframe provides visually-different, but related content display functionalities to other visual elements, including, but not limited to: popup windows; surveys; rating requests; social media content; and forms.

FIG. 1A illustrates a particular embodiment of the invention, shown within an email message 101 displayed on a smartphone 103 via the email client 103A of smartphone 103. Email message 101 contains a sending timestamp 107 indicating when the sender sent email message 101 (in relation to current date and time 105), and an email body 109, which further contains a ribbon 121 having a set of images, a subset of which are visible at any one time (illustrated in FIG. 1A as images 131, 133, and 135) which smoothly scroll across the screen in a direction 125, and periodically stop moving, so that the recipient can conveniently view the entire set of images on ribbon 121, and conveniently click or tap on a selected image to see additional information. After a short time interval, ribbon 121 resumes smooth scrolling in direction 125.

The term “image” herein denotes content that includes both graphics and text. In a related embodiment of the invention, an HTML block can be used as an “image”.

FIG. 1B illustrates the particular embodiment shown in FIG. 1A, after a short time interval has passed (typically a few seconds). In FIG. 1B, ribbon 121 has scrolled to show images 133 and 135 farther along in direction 125, with a new image 137 appearing on the right of the display. Image 131 does not display at this time.

FIG. 1C illustrates the particular embodiment shown in FIG. 1A, after an additional short time interval has passed (typically a few seconds more). In FIG. 1C, ribbon 121 has scrolled to show images 133 and 135 farther along in direction 125, with image 131 re-appearing on the right of the display. Image 133 does not display at this time.

That is, in this non-limiting example, ribbon 121 contains four images: images 131, 133, 135, and 137, three of which are completely visible at any given time when email message 101 is being displayed.

FIG. 1D illustrates the particular embodiment shown in FIG. 1A, after a longer time interval has passed (such as several weeks after receiving email message 101). Current date and time 111 shows that such a time interval has passed since email 101 was sent (as noted in timestamp 107). In the interim, several items of content in ribbon 121 have changed. Image 131 (FIG. 1A-1C) is replaced by an image 131A (showing, in a non-limiting example, a price reduction), and image 135 has been replaced with an image 139 showing a different offer. In this embodiment of the invention, the original email message 101 is still being viewed by the recipient, but the content in the dynamic ribbon has been updated automatically to reflect the current status of the offers related to the content, without having to send the recipient a new email message.

### HTML Iframes

An HTML iframe is a HTML document embedded within another HTML document, such that the embedded iframe is dynamically independent of the embedding document. Iframes are typically embedded within website code to insert content from an outside source, such as an advertisement, but according to embodiments of the present invention, an iframe is also embeddable within an email message, and is thus transmitted, received, and viewed along with the email message. To the embedding code, an iframe behaves like an inline image, but may be configured with its own controls, such as buttons, scrollbars, and the like.

The term “scroller” herein denotes a mechanism for automatically scrolling the content of a ribbon or similar graphical element, such that the scrolling is done without the need for user interaction (for example, without having to use a swipe gesture or clicking on a scrollbar).

The term “user” herein denotes a recipient of an email message, as well as a person who uses a device to receive an email message. The terms “user” and “recipient” are herein interchangeable according to context.

Therefore, according to an embodiment of the present invention there is provided a method for including a dynamic ribbon in an email message for a recipient, the method including: (a) preparing an HTML block for inclusion in the email message, the HTML block for displaying a plurality of images to a recipient of the email message when the recipient opens the email message; and (b) preparing iframe code containing: (c) a plurality of unique links to respective images of the plurality of images, for creating a display of the plurality of images as the dynamic ribbon; and (d) a scroller for automatically scrolling the display of the plurality of images; (e) wherein: the HTML block contains a reference to an iframe; and (f) the iframe is operative to receive and run the iframe code when the recipient opens the email message using an email client.

In addition, according to another embodiment of the present invention there is provided a system for providing an email message to a recipient, wherein the email message contains a dynamic ribbon, the system comprising at least one server arranged to: (a) provide an HTML block for inclusion in the email message, the HTML block for displaying a plurality of images to a recipient of the email message when the recipient opens the email message; and (b) provide iframe code containing: (c) a plurality of unique links to respective images of the plurality of images, for creating a display of the plurality of images as the dynamic ribbon; and (d) a scroller for automatically scrolling the display of the plurality of images; (e) wherein: the HTML block contains a reference to an iframe; and (f) the iframe is operative to receive and run the iframe code when the recipient opens the email message using an email client.

### BRIEF DESCRIPTION OF THE DRAWINGS

The subject matter disclosed may best be understood by reference to the following detailed description when read with the accompanying drawings in which:

FIG. 1A illustrates an email message as viewed on a recipient's device, according to a particular embodiment of the present invention.

FIG. 1B illustrates the email message of FIG. 1A, as subsequently viewed on the user device after a short time interval, according to the particular embodiment of the present invention.

FIG. 1C illustrates the email message of FIG. 1A, as subsequently viewed on the recipient's device after an additional short time interval, according to the particular embodiment of the present invention.

FIG. 1D illustrates the email message of FIG. 1A, as subsequently viewed on the recipient's device after a longer time interval, according to another embodiment of the present invention.

FIG. 2 is a conceptual diagram of a system according to an embodiment of the present invention.

FIG. 3 is a flowchart of a method according to an embodiment of the invention.

FIG. 4 conceptually illustrates the structure of HTML code according to an embodiment of the invention.

FIG. 5 conceptually illustrates the structure of an HTML <iframe . . . > referenced code object according to an embodiment of the invention.

FIG. 6 conceptually illustrates the possible components of a dynamic ribbon according to an embodiment of the invention.

FIG. 7 is a flowchart of a method for providing fallback, according to an embodiment of the invention.

FIG. 8 conceptually illustrates the composition of personalization data, according to an embodiment of the invention.

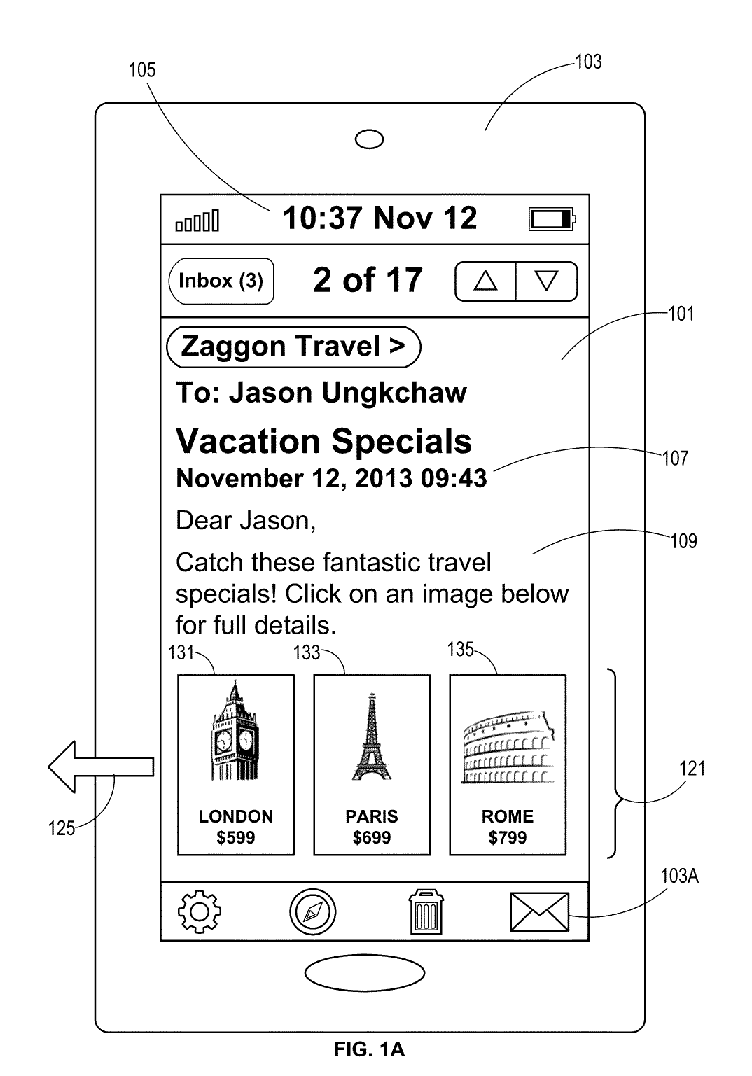

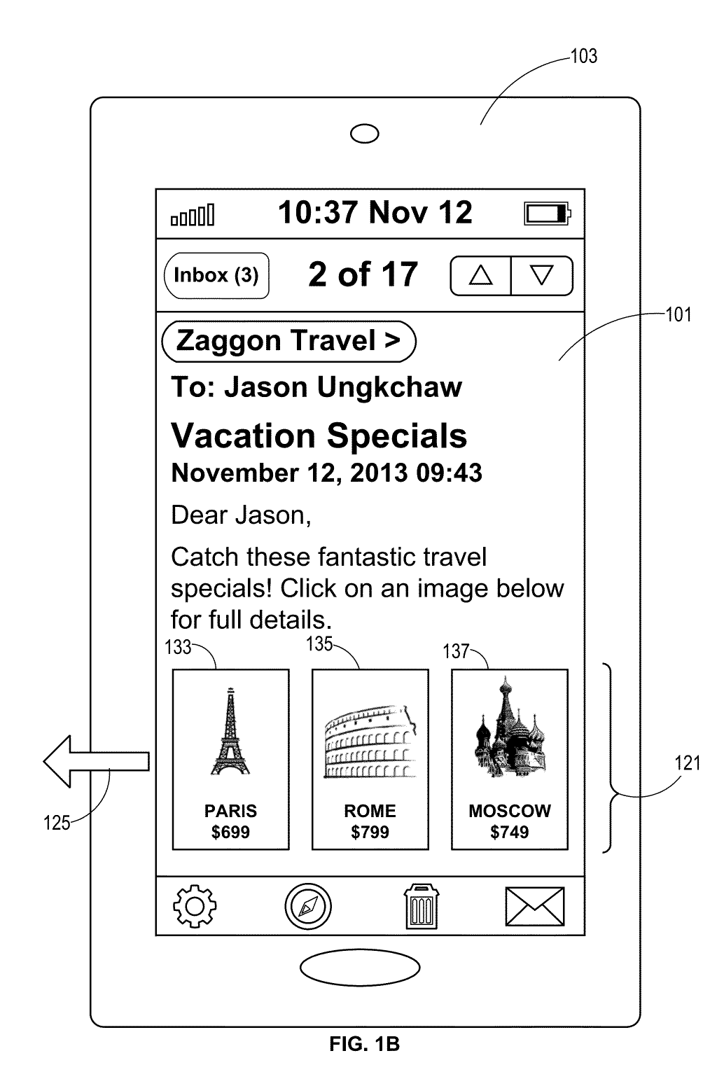

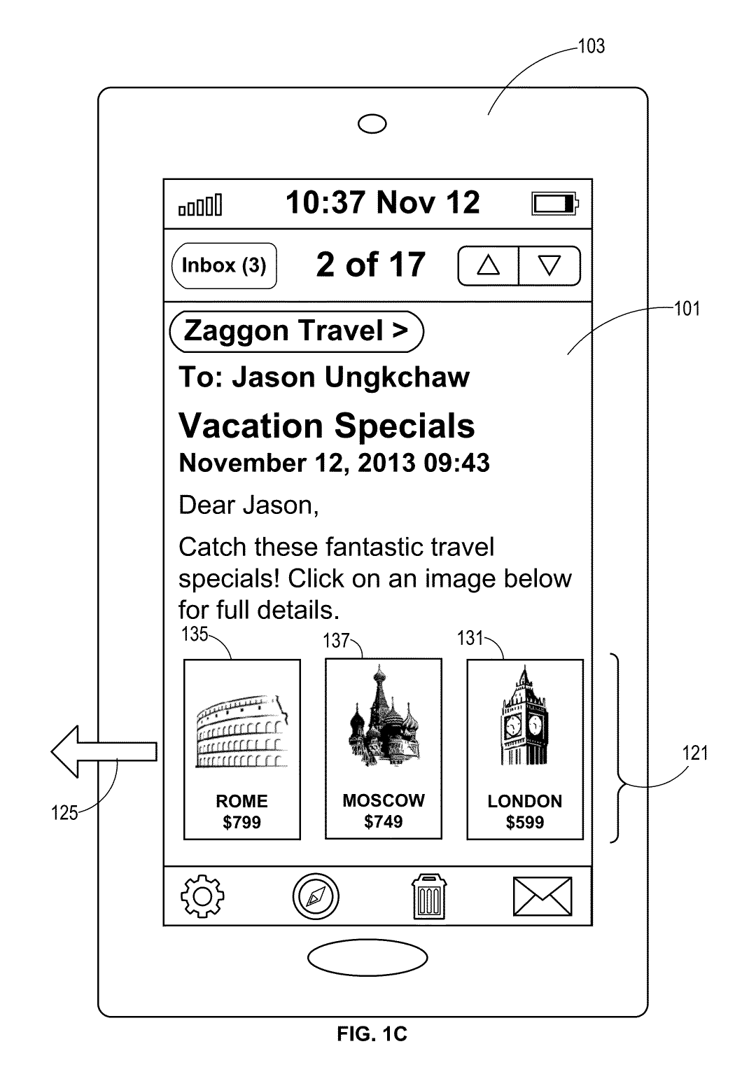

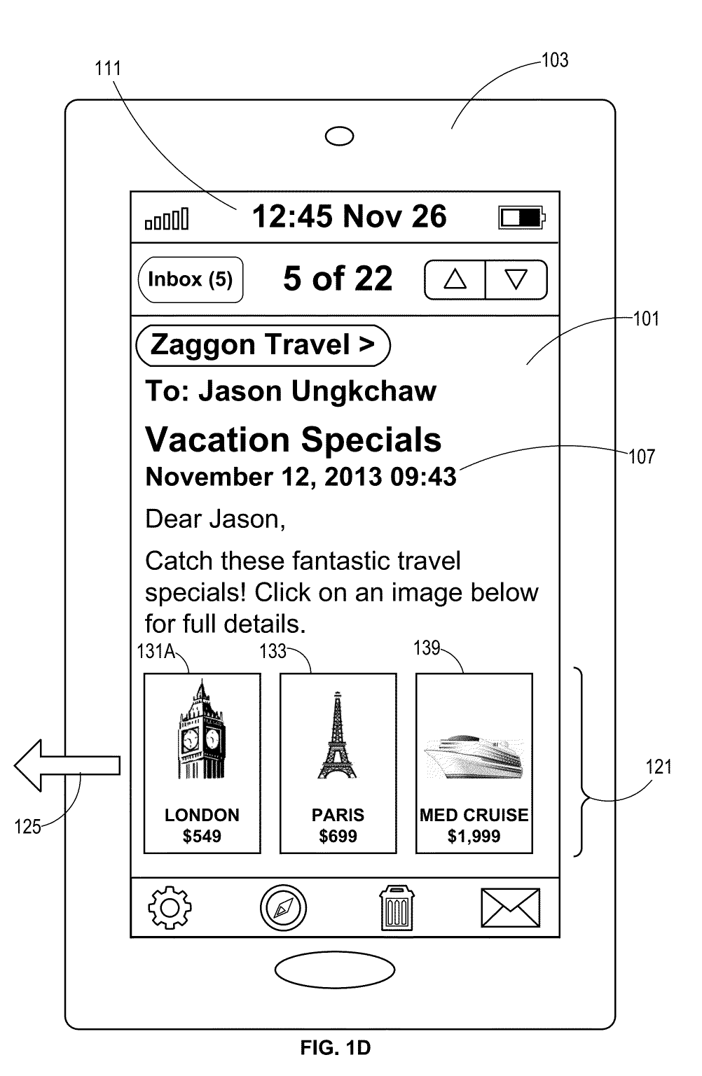

For simplicity and clarity of illustration, reference numerals may be repeated among the figures to indicate corresponding or analogous elements.

### DETAILED DESCRIPTION

Certain embodiments of the invention provide presentation of dynamic content as rendered and run within various email clients based on HTML5 and CSS3 support, typically through transitions and animations.

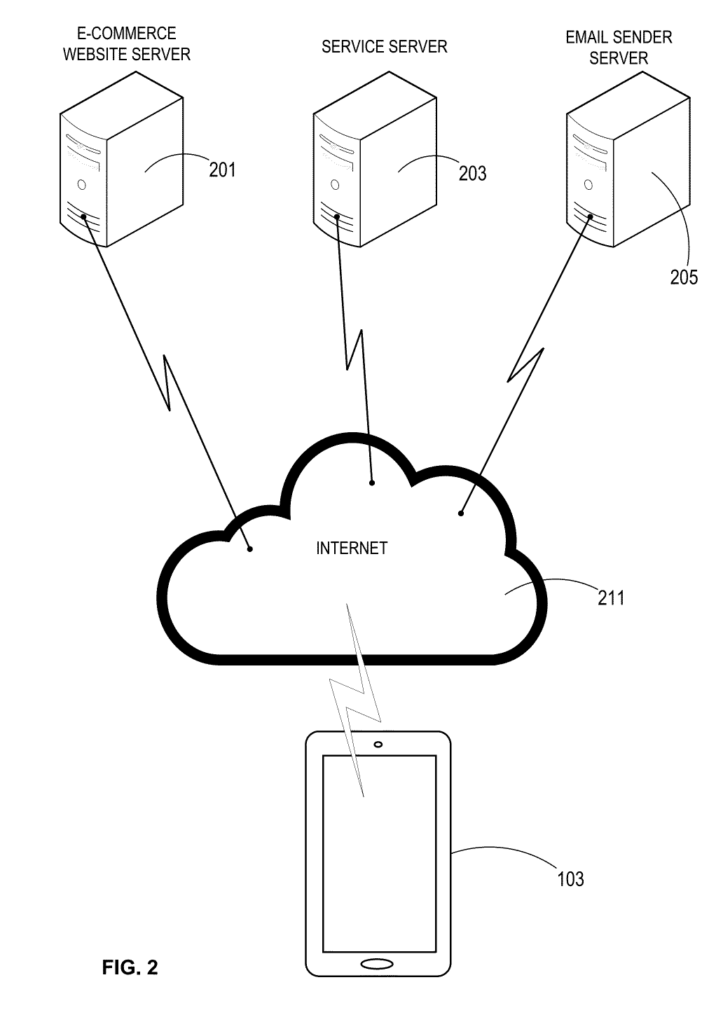

As shown in FIG. 2, a system according to an embodiment of the invention includes an e-commerce website server 201, a service server 203, and an email sender server 205, all of which are connected to the Internet 211. Servers 201, 203, and 205 are shown as physically separate devices, but in practice may be logically-separate devices which may occupy the same physical equipment. Recipient device 103 receives an email message sent by email sender server 205 via Internet 211.

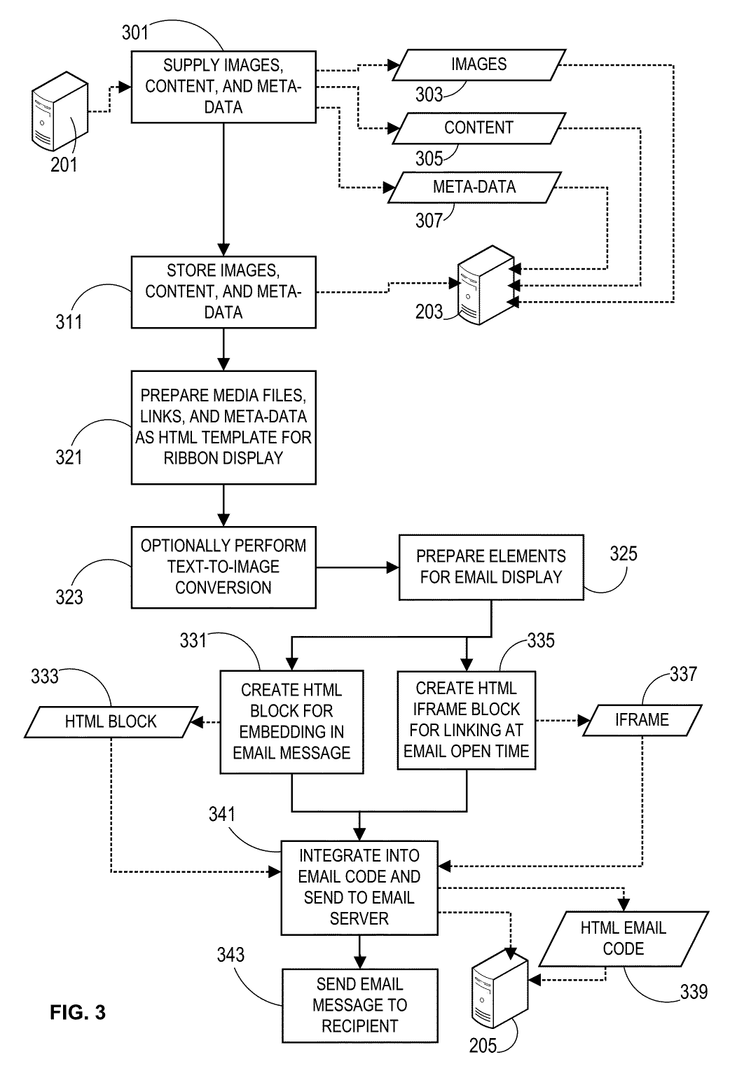

FIG. 3 is a flowchart of a method according to an embodiment of the invention. In a step 301, e-commerce website server 201 supplies images 303, content 305, and meta-data 307, and in a step 311, service server 203 stores images 303, content 305, and meta-data 307.

According to various embodiments of the invention, data sources can be images, video, media files, or text of any suitable type. In related embodiments, e-commerce metadata is embedded within the media file, or in an external file, and contains text and numerical data including, but not limited to:

item link (URL);

title;

description;

cost;

time left;

number purchased;

rating;

recommendation;

reviews; and

related items.

In a step 321 service server 203 prepares media files (such as images), links, and meta-data as an HTML template for a ribbon display in an email message. In an optional step 323, service server 203 performs a text-to-image conversion, if needed.

In a step 325, service server 203 prepares the elements for inclusion in email for displaying the ribbon content.

In one related embodiment, service server 203 performs a step 331 to create an HTML block 333. In another related embodiment, service server 203 performs a step 335 to create an <iframe . . . > 337. In either case, HTML block 333 and <iframe . . . > 337 are integrated into email HTML code 339, which is sent to email sender server 205. Finally, in a step 343, email sender server 205 sends the email message to the recipient's device via the recipient device email client.

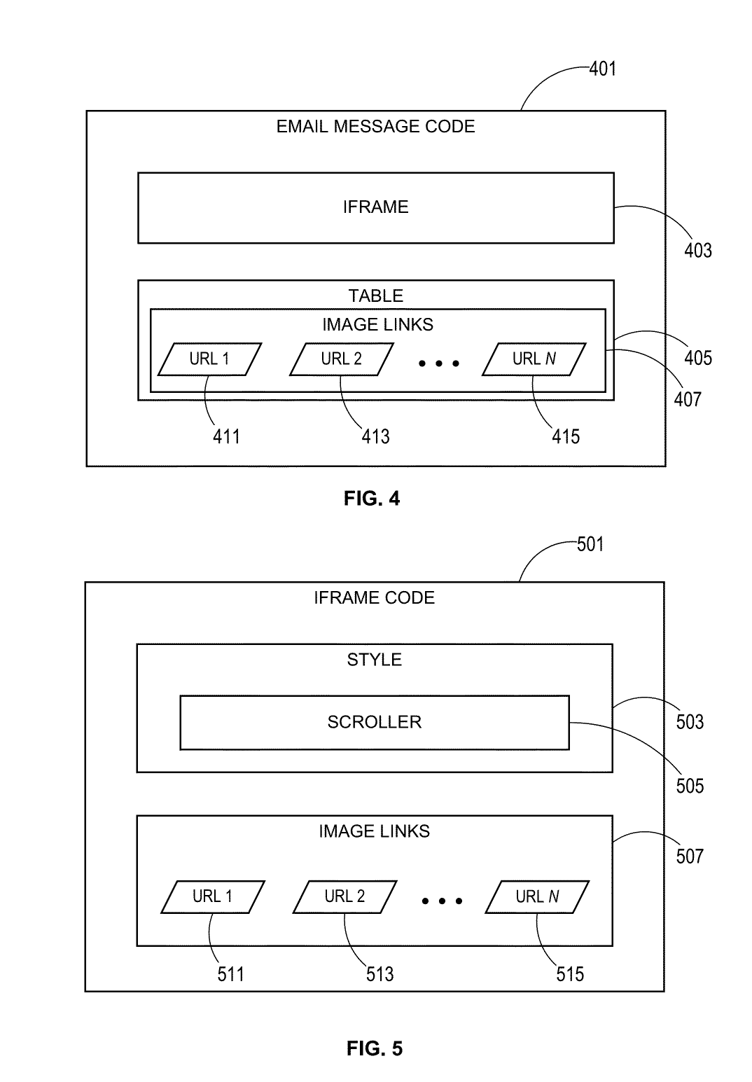

FIG. 4 conceptually illustrates the structure of HTML email message code 401 according to an embodiment of the invention. Email message code 401 contains an <iframe . . . > element 403 and a table element 405. It is noted that <iframe . . . > element 403 provides the code and style information that animates the ribbon.

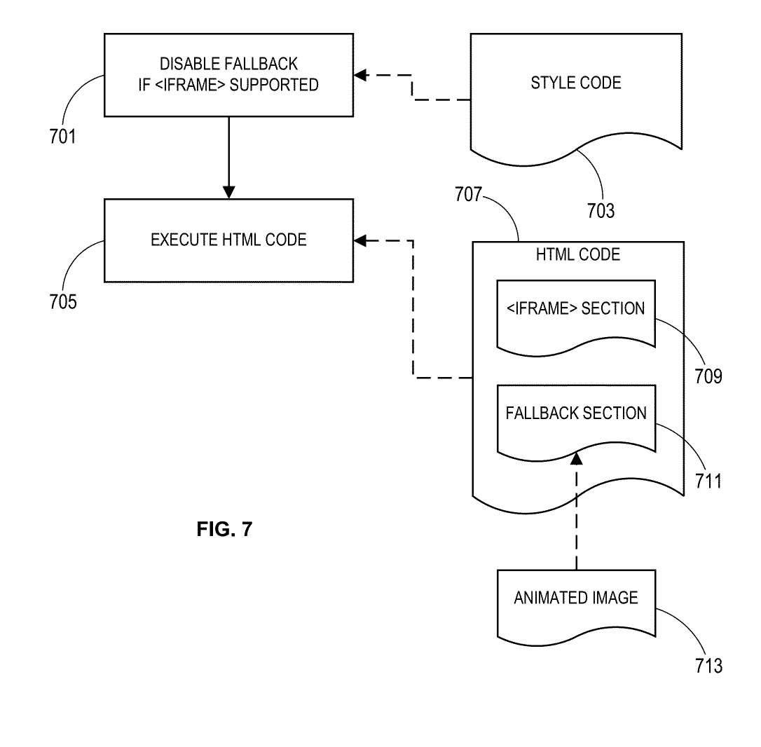

Table element 405 is provided as a fallback in case the email client does not support <iframe . . . > element 403, as further discussed herein with reference to FIG. 7. The table defined by table element code 405 and contains image links 407, with exemplary links URL 1 411, URL 2 413, and URL N 415. According to various embodiments, image links 407 are unique, such that for any plurality of images displayed in a dynamic ribbon, the respective image links are unique for that dynamic ribbon. In a related embodiment, a link can be to an animated image, such as a GIF image. As discussed further herein, where the email client supports <iframe . . . > element 403, the table defined by table element 405 is hidden from view on the screen by a style definition that renders the table size as 0 (e.g., using a CSS3 style definition).

FIG. 5 conceptually illustrates the structure of an HTML <iframe . . . > referenced code object 501 according to an embodiment of the invention. Code object 501 contains a style definition 503 which includes a scroller definition 503, such as provided by CSS3, to animate the ribbon.

Using <iframe . . . > permits the email to be more dynamic and continually up-to-date, because the core HTML code is downloaded at runtime whenever the recipient accesses the email message for viewing. Email server 205 provides the media elements (e.g., via the <img src . . . > tag) to the recipient's email client. To the email client, this may appear to be a static link, but email server 205 decides at runtime what is the proper data to send to the email client. When the email client renders the HTML block or the <iframe . . . > it receives both dynamic data and movement/animation styles. In an additional embodiment, when the email client fetches data, email sender server 205 collects statistics regarding clicks and other activity performed by the recipient within the email message.

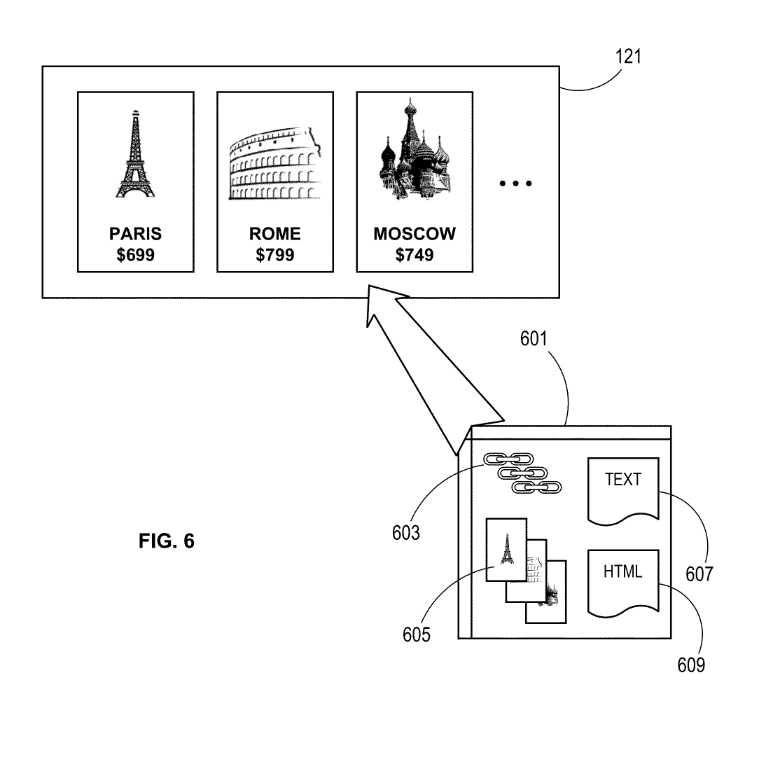

FIG. 6 conceptually illustrates the possible components 601 of dynamic ribbon 121 according to an embodiment of the invention. Components 601 may include such elements as one or more links 603, images, videos, animations, and the like 605, text 607, and HTML code 609.

FIG. 7 is a flowchart of a method for providing fallback, according to an embodiment of the invention which displays dynamic content in an email message for email clients that do not support <iframe ...>, and thus are unable to show the sliding ribbon. A default fallback is provided with the email message as a contingency measure, and in a step 701, the default fallback is disabled by style code 703 if an <iframe . . . > section 709 exists during an execution 705 of HTML code 707.

Style code 703 is typically of the form:

<style>iframe+.fallback{display: none !important;}</style>

<iframe . . . > section is typically of the form:

<iframe src=“. . . ></iframe>,

Whereas a default fallback section 711 is typically of the form:

<table class=“fallback” ><table>

According to this embodiment of the invention, in place of the iframe, an animated image 713 (such as a GIF file) is displayed, with items that would have otherwise appeared in the iframe, and having with animated effects including, but not limited to fade in/fade out.

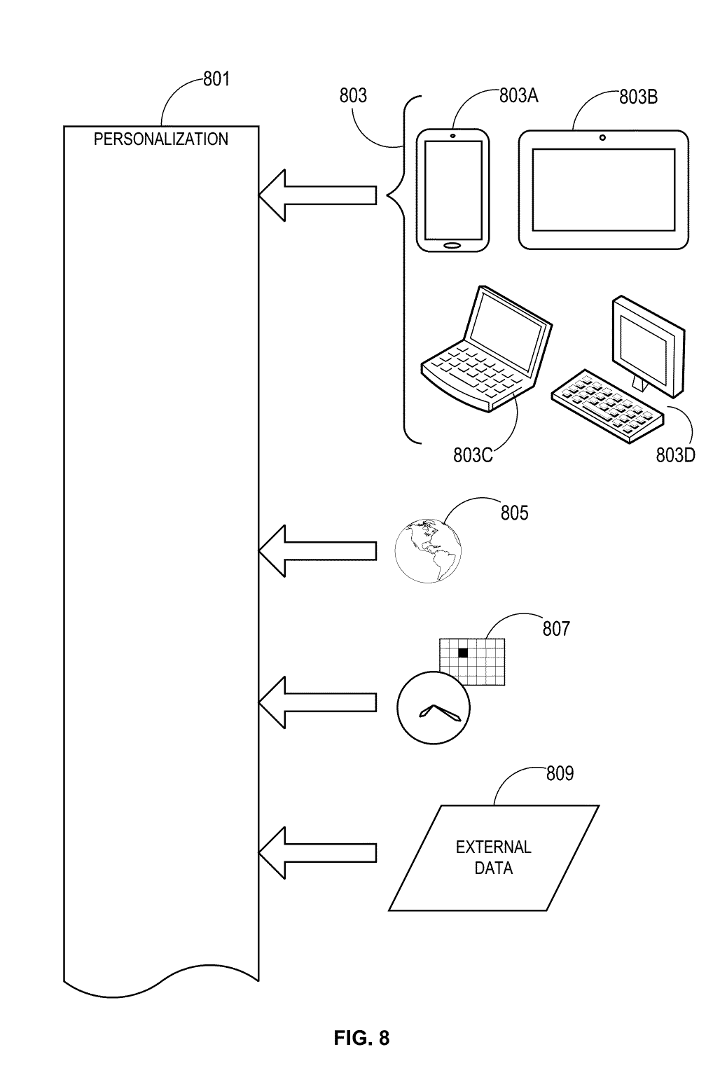

According to various embodiments of the invention, which can be employed both individually and in combination, the content of the ribbon is personalized for the recipient of the email when the email is opened, by means of applying a personalization data structure 801 as illustrated in FIG. 8. In one embodiment, the personalization is done according to the user's device 803, non-limiting examples of which include a smartphone 803A, a tablet computer 803B, a notebook computer 803C, and a desktop computer 803D; in another embodiment, the personalization is done according to a geographical location 805; in a further embodiment, the personalization is done according to the user's email address; in still another embodiment, the personalization is done according to the date and/or time of day 807; and in a related embodiment, the personalization is done according to data 809 from an external data source (a non-limiting example of which is a date and/or time specified by the external data source). In a related embodiment, personalization data structure 801 is included within metadata 307 in service server 203 (FIG. 3).

In various additional embodiments of the invention, personalization is accomplished via data scraping of websites. In one embodiment, personalization 801 includes data 803 based on merge tags in email messages. In another embodiment, personalization 801 includes data 803 based on aggregated information about the user (from internal and/or external data sources) in conjunction with personalization matching algorithms.

In various further embodiments of the invention, ribbon content is selected automatically prior email open time. In a related embodiment, content selection is according to collected data, including, but not limited to A/B testing and hit statistics.

What is claimed is:

1. A method for including a dynamic ribbon in an email message for a recipient, the method comprising:
preparing an HTML block for inclusion in the email message, the HTML block for displaying a plurality of images to a recipient of the email message when the recipient opens the email message; and
preparing iframe code containing:
a plurality of unique links to respective images of the plurality of images, for creating a display of the plurality of images as the dynamic ribbon; and
a scroller for automatically scrolling the display of the plurality of images;
wherein:
the HTML block contains a reference to an iframe; and
the iframe is operative to receive and run the iframe code when the recipient opens the email message using an email client.

2. The method of claim 1 further comprising a fallback method for displaying default dynamic content in a email message for an email client that does not support the iframe, the fallback method including:
providing an animated image to display as a default fallback; and
providing style code to disable the default fallback if the email client supports the iframe.

3. The method of claim 1, based on HTML5 and CSS3.

4. The method of claim 2, based on HTML5 and CSS3.

5. The method of claim 1, further comprising applying a personalization for the recipient.

6. The method of claim 4, wherein the personalization is selected from a group consisting of:
a device;
a geographical location;
an email address;
a date;
a time; and
external data.

7. A system for providing an email message to a recipient, wherein the email message contains a dynamic ribbon, the system comprising at least one server arranged to:
provide an HTML block for inclusion in the email message, the HTML block for displaying a plurality of images to a recipient of the email message when the recipient opens the email message; and
provide iframe code containing:
a plurality of unique links to respective images of the plurality of images, for creating a display of the plurality of images as the dynamic ribbon; and
a scroller for automatically scrolling the display of the plurality of images;
wherein:
the HTML block contains a reference to an iframe; and
the iframe is operative to receive and run the iframe code when the recipient opens the email message using an email client.

8. The system of claim 7, wherein the HTML block further contains a fallback section for displaying default dynamic content in a email message for an email client that does not support the iframe; and wherein the at least one server is further arranged to provide:
an animated image for display as a default fallback;
style code to disable the default fallback if the email client supports the iframe block.

9. The system of claim 7, based on HTML5 and CSS3.

10. The system of claim 8, based on HTML5 and CSS3.

11. The system of claim 7, wherein the service server is further arranged to provide personalization data for the recipient.

12. The system of claim 11, wherein the personalization data is selected from a group consisting of:
a device;
a geographical location;
an email address;
a date;
a time; and
external data.
